(19) United States
(12) Patent Application Publication
(10) Pub. No.: US 2015/0189017 A1
(43) Pub. Date: Jul. 2, 2015

(54) COOPERATIVE NODES IN A CONTENT DISTRIBUTION NETWORK

(71) Applicant: Sonic IP, Inc., Santa Clara, CA (US)

(72) Inventors: William Amidei, La Jolla, CA (US); Francis Chan, San Diego, CA (US); Eric Grab, San Diego, CA (US); Michael Kiefer, Lake Havasu City, AZ (US); Aaron McDaniel, La Mesa, CA (US); John Mickus, San Marcos, CA (US); Ronald Mombourquette, San Diego, CA (US); Nikolai Popov, Tierrasanta, CA (US); Fred Zuill, Poway, CA (US)

(73) Assignee: Sonic IP, Inc., Santa Clara, CA (US)

(21) Appl. No.: 14/144,955

(22) Filed: Dec. 31, 2013

(51) Int. Cl. H04L 29/08; H04L 29/06

(52) U.S. Cl. CPC H04L 67/1097; H04L 63/10

(57) ABSTRACT

Methods and systems to improve the efficiency of a content delivery system. A local distribution node is introduced to the network, between the content provider and the end user device (i.e., the leaf node). The local distribution node is responsible for servicing a localized subset of the leaf nodes that would otherwise be serviced by a conventional server of the content delivery system. Requests for content are received at the local distribution node from leaf nodes, and content is received at the local distribution node for transmission to the leaf node(s). Content may be cached at the local distribution node to allow faster service of subsequent requests for this content. Caching may also be used to make the channel surfing process more efficient. If demand is high, a leaf node may be promoted to serve as an additional local distribution node. Leaf nodes may also share content among themselves. Bandwidth may be allocated and reallocated by the local distribution node for the local population of leaf nodes.

### BACKGROUND

In current content distribution systems, a content provider may use a number of servers to provide content to users. At any given time, a server may be responsible for handling the requests of a large population of users. The quality of service provided to users can vary, depending on a variety of parameters. These include, for example, the number of users, the frequency of their requests, the volume of data being requested, the topology of the content distribution network, and the infrastructure of the network from the server to each user. Moreover, other issues may affect the level of demand placed on the distribution system. Demand for entertainment may increase on weekends, for example; new releases of certain types of content, such as popular movies, trailers, or music videos may increase demand as well.

As a result of the demands placed on a content distribution network and its infrastructure, the user experience can sometimes be frustrating. The distribution process can be slow and inefficient in some circumstances, and can appear unresponsive to the user. Streaming may be slow to begin, and may then appear to pause or stutter for example. Downloads may take a long time to complete. The frustration can be compounded if the user is required to pay for access to the desired content, and receives slow service.

### BRIEF DESCRIPTION OF THE DRAWINGS/FIGURES

FIG. 1A-1C are block diagrams of exemplary topologies for the system described herein, according to an embodiment.

FIG. 2 is a flowchart illustrating caching at a local distribution node, according to an embodiment.

FIG. 3 is a flowchart illustrating access determination, according to an embodiment.

FIG. 4 is a flowchart illustrating the determination of whether content is to be cached, according to an embodiment.

FIG. 5 is a flowchart illustrating the determination of whether content in the cache is to be released, according to an embodiment.

FIG. 6 is a flowchart illustrating network configuration, according to an embodiment.

FIG. 7 is a flowchart illustrating the determination of whether the load at local distribution node is high, according to an embodiment.

FIG. 8 is a flowchart illustrating leaf promotion, according to an embodiment.

FIG. 9 is a flowchart illustrating leaf demotion, according to an embodiment.

FIG. 10 is a flowchart illustrating the determination of whether processing load is low at a promoted node, according to an embodiment.

FIG. 11 is a flowchart illustrating content distribution from other leaf nodes, according to an embodiment.

FIG. 12 is a flowchart illustrating a request for content from another leaf node, according to an embodiment.

FIG. 13 is a flowchart illustrating bandwidth allocation, according to an embodiment.

FIG. 14 is a flowchart illustrating the determination of bandwidth parameters, according to an embodiment.

FIG. 15 is a flowchart illustrating the determination of bandwidth needs, according to an embodiment.

FIG. 16 is a flowchart illustrating an amount of bandwidth to be allocated, according to an embodiment.

FIG. 17 is a flowchart illustrating the processing of channel surfing, according to an embodiment.

FIG. 18 is a flowchart illustrating the determination of whether channel susrfing is taking place, according to an embodiment.

FIG. 19 is a block diagram illustrating a computing environment at a local distribution node, according to an embodiment.

FIG. 20 is a block diagram illustrating a computing environment at a leaf node, according to an embodiment.

In the drawings, the leftmost digit(s) of a reference number identifies the drawing in which the reference number first appears.

### DETAILED DESCRIPTION

Disclosed herein are methods and systems to improve the efficiency of a content delivery network. A local distribution node is introduced to the network, between the content provider and the end user device (i.e., the topological leaf node, if the network is modeled as a graph). The local distribution node is responsible for servicing a localized subset of the leaf nodes that would otherwise be serviced by a conventional server of the content delivery system. Such a local distribution node may service a single residential neighborhood or apartment complex for example. Requests for content are received at the local distribution node from leaf nodes, and content is received at the local distribution node for transmission to the leaf nodes. Under certain circumstances, content may be cached at the local distribution node to allow faster service of subsequent requests for this content.

Caching may also be used to make channel surfing process more efficient; low bandwidth “microtrailers” for each of several consecutive channels may be obtained by the local distribution node and cached. These microtrailers can then be quickly dispatched to a leaf node sequentially, allowing for efficient servicing of a channel surfing user.

Flexibility can be built into this system in several ways. If demand is high, a leaf node may be promoted to serve as an additional local distribution node, then demoted if demand subsides. Leaf nodes may also share content among themselves, which thereby provides a faster, more convenient way to obtain content for a user. Bandwidth may be allocated and reallocated by the local distribution node for the local population of leaf nodes, based on demand and contingent on infrastructure limitations.

Local Distribution Node

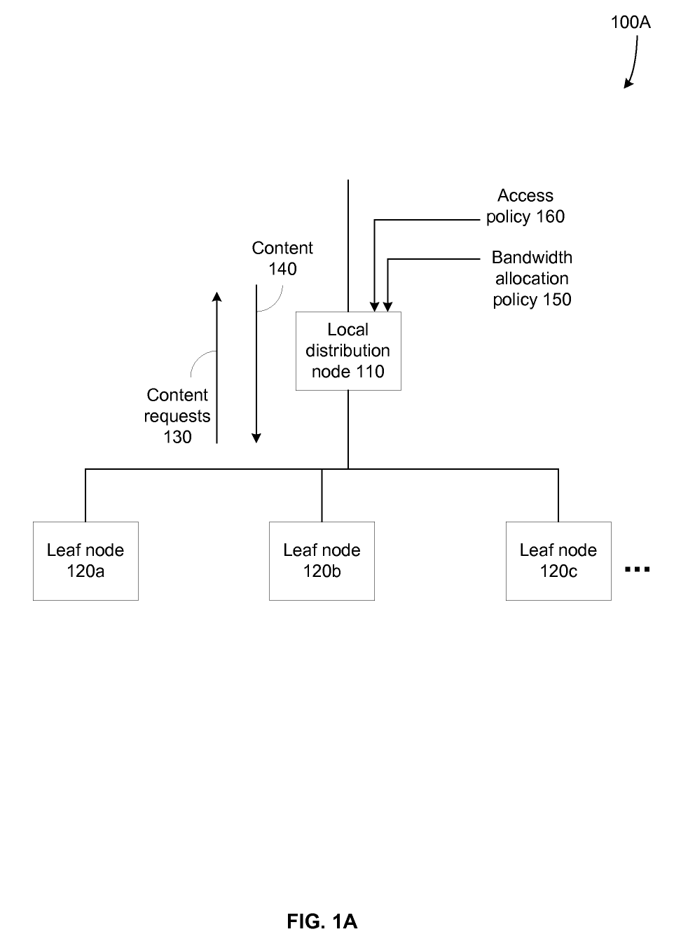

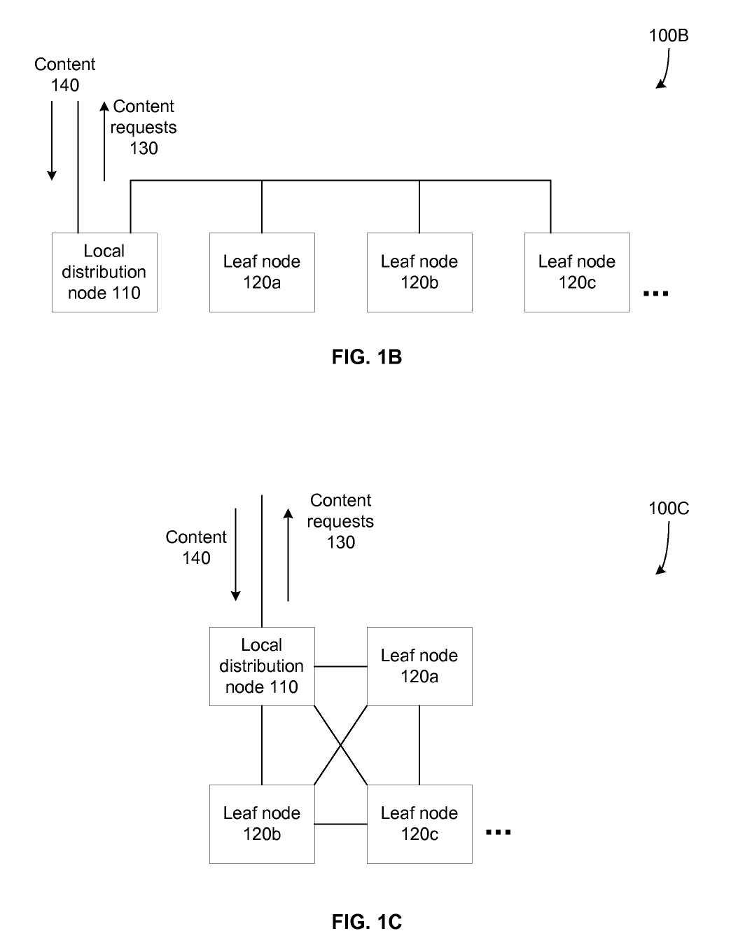

Example topologies for such a system are illustrated in FIGS. 1A-1B, according to various embodiments. In FIG. 1A, a local distribution node 110 is shown in communication with several leaf nodes 120a . . . c; moreover, each of the leaf nodes is in communication with each other. Physically, a leaf node may be a user device for the receipt and consumption of content 140. Examples may include set top boxes (STBs) and desktop and portable computing devices. While three leaf nodes are shown, it is to be understood that in various embodiments, more or fewer than three leaf nodes may be present. Content 140 may include, for example, audio and/or video data, image data, text data, or applications such as video games.

The local distribution node 110 may likewise be an STB or desktop or portable computing device, and may have server functionality. In an embodiment, the local distribution node 110 receives a request 130 for content 140, where the request comes from one or more leaf nodes 120. The request 130 is conveyed by local distribution node 110 to a server of a content provider (not shown) as necessary. The requested content 140 may then be received at the local distribution node 110 from the content provider and forwarded to the requesting leaf node(s) 120. In some situations the requested content may already be present at the local distribution node 110, as will be discussed below. In this case, the local distribution node will not necessarily have to contact the content provider. Communications between the local distribution node 110 and the leaf nodes 120 may take place using any communications protocol known to persons of ordinary skill in the art.

As will be discussed below, the provision of requested content 140 may be contingent on whether the request is consistent with an access policy. Such a policy would specify that a certain user, or the leaf node associated with the user, is or is not authorized to access certain content. This may be based on a particular subscription package purchased by the user, or on specified parental controls, for example. Such an access policy 160 is sent to and enforced by the local distribution node 110 in the illustrated embodiment. The access policy 160 may be provided to the local distribution node by a policy server (not shown). Alternatively, the access policy 160 may be enforced at the content provider, or at the individual leaf nodes. In an embodiment, the policy server may be incorporated in a content server of the content provider.

In an embodiment, the local distribution node 110 may also be capable of allocating and reallocating bandwidth to the leaf nodes 120. Such allocation may be performed in accordance with a bandwidth allocation policy 150. Such a policy 150 may be distributed from a bandwidth policy server (not shown) that may be the same physical device as the content server or access policy server. The bandwidth allocation policy 150 may be enforced at the local distribution node 110 or at the content provider, in various embodiments.

An alternative topology is shown in FIG. 1B. In the illustrated embodiment, the local distribution node 110 is a peer of the leaf nodes 120, all of which are in communication with each other. As in the case of FIG. 1A, content requests 130 are received at the local distribution node 110 and conveyed to the content provider if necessary; requested content 140 is received (and may be cached) at local distribution node 110 and routed to the requesting leaf node(s). Access and bandwidth allocation policies may be implemented in a manner similar to that described above with respect to FIG. 1A.

Another alternative topology is shown in FIG. 1C. In the illustrated embodiment, the local distribution node 110 is again a peer of the leaf nodes 120. The nodes in this case are all in direct communication with each other. As in the case of FIG. 1A, content requests 130 are received at the local distribution node 110 and conveyed to the content provider as needed; requested content 140 is received (and may be cached) at local distribution node 110 and routed to the requesting leaf node(s). Access and bandwidth allocation policies may be implemented in a manner similar to that described above with respect to FIG. 1A.

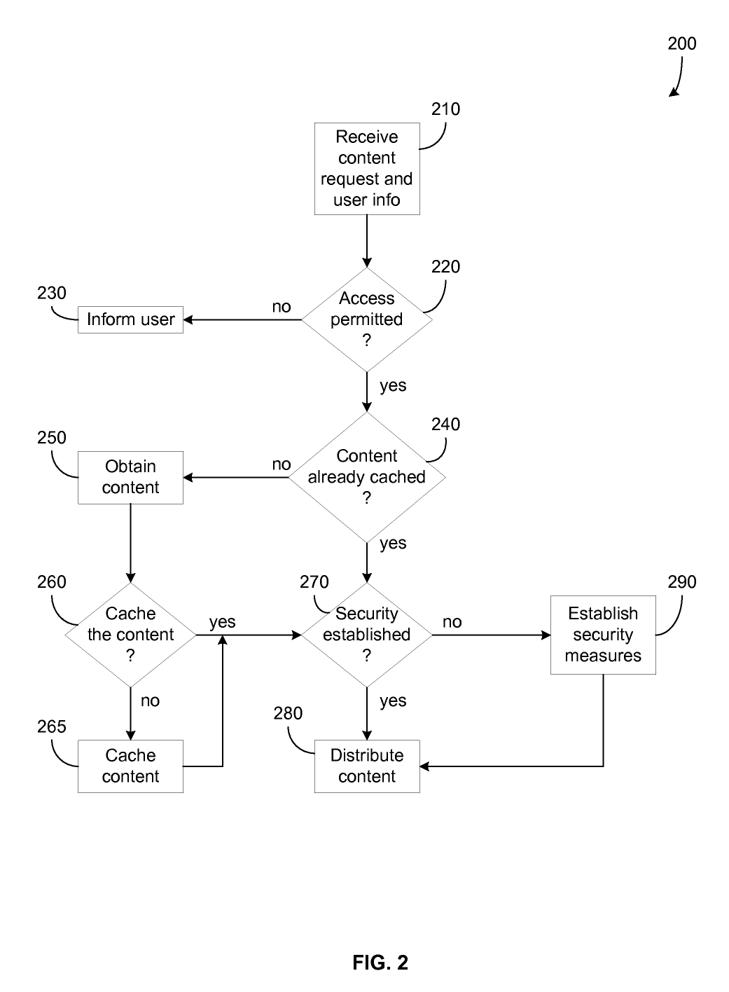

Processing at the local distribution node includes the operations shown in FIG. 2, according to an embodiment. At 210 the local distribution node receives a content request from a leaf node. In the illustrated embodiment, this request includes not only an identifier of the requested content, but also includes information about the user and/or the leaf node. This information is used to determine access rights, e.g., whether the user has paid for access to the requested content and/or whether access to the requested content is consistent with any parental controls for example. If access is not permitted, the user is so informed.

Otherwise, a determination is made at 240 as to whether the requested content is already cached at the local distribution node. If not, the content is obtained by the local distribution node from the content provider (250). Once the content is obtained, a determination is made as to whether to cache this content at 260. The process for making this determination will be described in greater detail below. If it is decided that caching is appropriate, then the requested content is cached at 265.

If the content is cached, then at 270 a determination is made as to whether appropriate security measures are in place for purposes of distribution of the content to the requesting leaf node. Such measures may include authentication, encryption, and/or any other privacy or digital rights management mechanisms. If necessary, such measures can be implemented at 290. In various embodiments, these measures may include key generation and/or key distribution processes, such as symmetric or public key protocols, and the use and verification of digital signatures. These examples of security-related processing are presented as examples and are not meant to be limiting, as would be understood by persons of ordinary skill in the art. Once the security measures are implemented, the content may be distributed to the requesting leaf node at 280.

The access permission determination (220 above) is illustrated in greater detail in

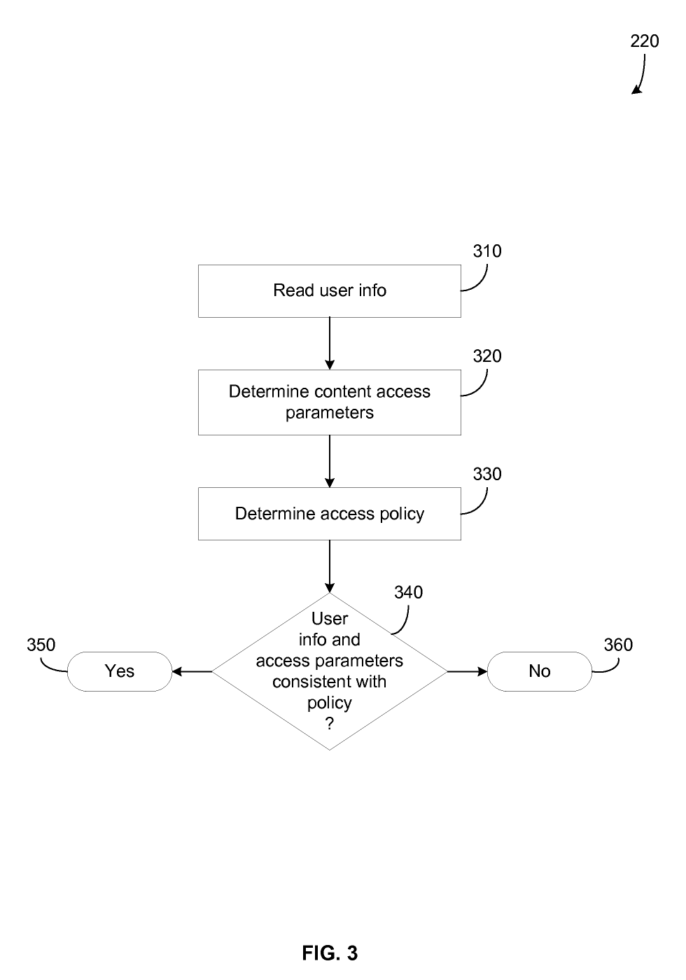

FIG. 3, according to an embodiment. At 310, the user information is read at the local distribution node. This information may identify the leaf node, the party associated with the leaf node from which the request is received and/or the party making the request. This information may also include information relating to the access privileges of the party or leaf node, e.g., that he is below a certain age, and/or that he is a subscriber to one or more particular content packages, but may not access another content package. At 320, access parameters related to the requested content are determined. These parameters represent properties of the content that are used in determining access. Examples may include an NC-17 rating, an extreme violence rating, or an association of the content with one or more particular subscription packages. At 330, the access policy may be determined. The access policy defines what parties or groups of parties may access particular content. The access policy may obtained from the content provider via an access policy server and stored at the local distribution node for reference; alternatively, the access policy may be accessed by the local distribution node at the content provider as necessary.

At 340 the access policy is applied to the user information and the content access parameters of the requested content. The result is a determination that the user information and the content access parameters are either consistent with the access policy (350) or that they are not (360).

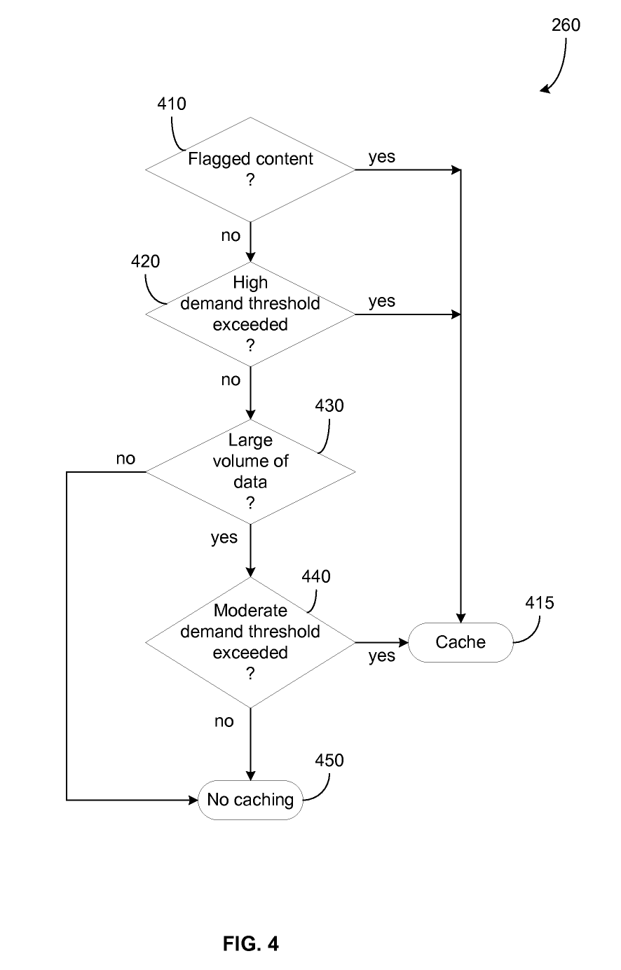

The decision as to whether to cache content at the local distribution node (260 above) may depend on several factors. Some of these factors are illustrated in the embodiment of FIG. 4. First, some content items may be pre-designated, or flagged, by the content provider as being popular and therefore likely to be requested often. Examples might include a championship sporting event, or a highly publicized concert or film for example. At 410, a determination is made as to whether content received from the content provider is so flagged. If so, it is presumed that this content will be requested frequently, so that caching is appropriate (415) in anticipation of these requests. Otherwise processing continues at 420.

At 420, it is determined whether a high demand threshold has been exceeded for the content item. Demand for an item may be measured by the number of times it has been requested in a current window of time, for example. If the content has been requested often enough in a current time window, it can be inferred that it is a popular content item and will likely be requested several more times in the immediate future. This indicates that caching of this content is appropriate (415). The high demand threshold may be defined empirically or arbitrarily in various embodiments.

At 430, it is determined whether the requested content represents a large volume of data. If so, and if the level of recent demand for this content is at least at some moderate level as determined at 440, then caching is appropriate (415). In this situation, having to obtain the large volume of data from the content provider may be onerous, and having to do so repeatedly compounds the demands placed on the system, creating latency. Hence, the use of the cache at the local distribution node would be advantageous (415). Otherwise, caching is not deemed necessary (450). The large volume threshold of 430 and the moderate demand threshold of 440 may be defined empirically or arbitrarily in various embodiments.

It should be understood that the processing shown in the embodiment of FIG. 4 is contingent on the availability of cache space. If there is insufficient space in the cache of the local distribution node, then the requested content item cannot generally be cached unless another content item is removed from the cache.

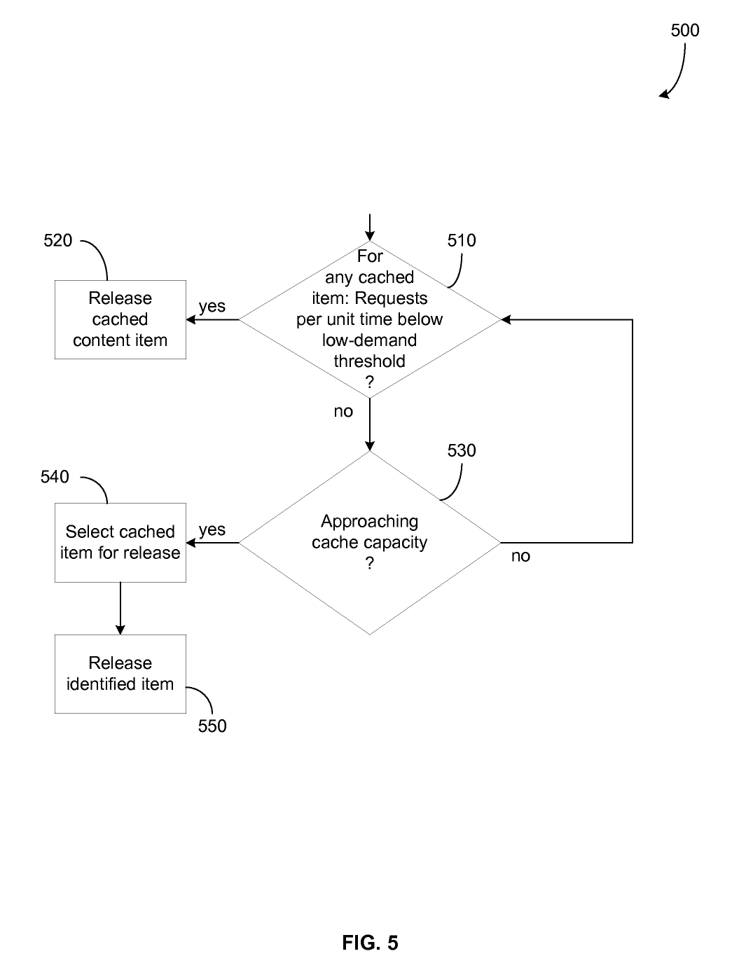

A process for removal of a content item from the local distribution node's cache is shown in FIG. 5, according to an embodiment. At 510, the cached content items are evaluated with respect to how often they are being requested. For any content item for which the requests are relatively infrequent, i.e., relatively few requests per unit time, then removal from the cache is merited. This is the case where the number of requests for an item, per unit time, falls below a low-demand threshold. If so, then the content item is released from the cache at 520. This low-demand threshold may be defined arbitrarily, or may be determined empirically.

If no cached content items are in this situation, but the cache is approaching maximum capacity (530), then at 540 a content item in the cache is identified for release. The determination of whether the cache is approaching capacity may be based on a threshold percentage of space used, for example. This threshold percentage may be arbitrary or determined empirically.

One or more criteria may be used to make the identification of 540, such as the length of time in the cache, the amount of demand for the content item, and/or the amount of cache space used by the item. Once an item is identified, it is removed at 550.

Network Configuration

As noted above, a local distribution node is responsible for servicing a plurality of leaf nodes, such as STBs and other computing devices. The local distribution node has a finite processing capability, like any other electronic device. Under some circumstances, the processing limits of the local distribution node may be approached. This would happen if there were an excessive number of requests for content, for example. In such circumstances the content distribution system can functionally reconfigure itself to create a second local distribution node to service the population of leaf nodes. This is done through recognition of a high activity level at the original local distribution node and promotion of a leaf node to the role of a second local distribution node.

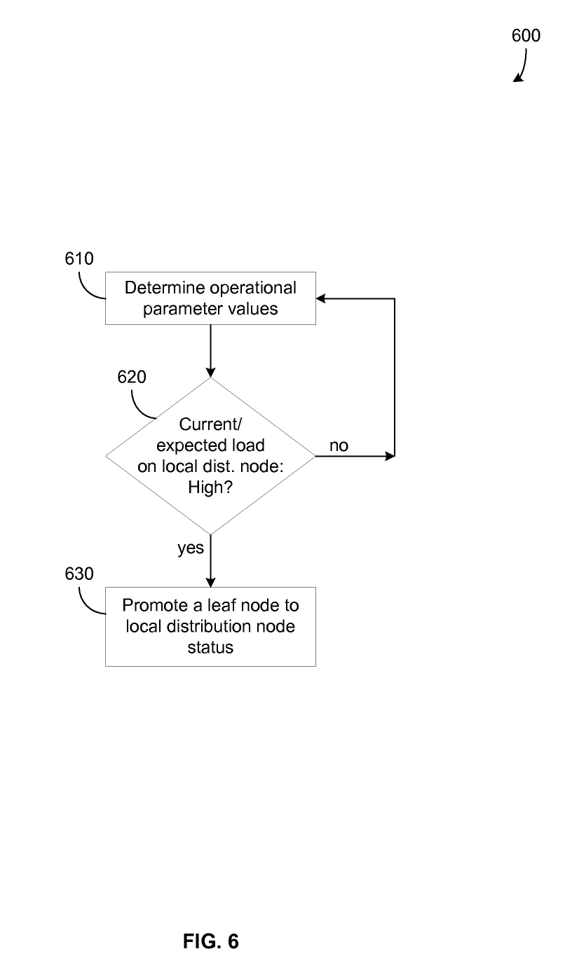

This is illustrated in FIG. 6, according to an embodiment. At 610, the values of operational parameters at the first local distribution node are determined. These parameters may include the number of content requests that have been received in a recent time window, the amount of data requested in this time window, the latency between receiving a request and delivery of content, and/or the amount of cache space currently in use. It is to be understood that these are examples of operational parameters that may be used to determine the level of processing activity at the first local distribution node; in alternative embodiments, some of these parameters may not be tracked, and other parameters may be considered aside from or in addition to any of the parameters listed here. Moreover, the parameters can also be tracked over time, to determine whether the processing load appears to be trending upwards towards a high level.

At 620, a determination is made as to whether the current and/or expected processing load at the local distribution node is high, based on the operational parameter values such as those discussed above. If so, then a leaf node can be promoted at 630 to function as another local distribution node.

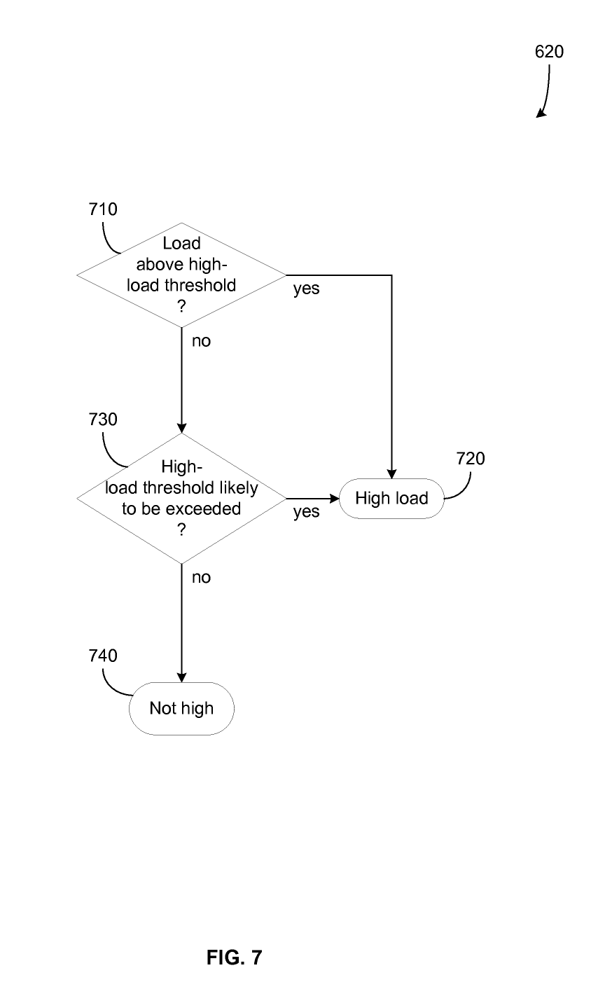

The determination 620 is illustrated in greater detail in FIG. 7, according to an embodiment. At 710, a determination is made as to whether the processing load is above a high load threshold. The load can be measured by using any or all of the parameters listed above, for example. The high load threshold may be a predefined value, and may be empirically or arbitrarily defined. If so, then the processing load is determined to be excessive (720). If not, processing continues at 730, where a determination is made as to whether the high load threshold, while not currently exceeded, is likely to be exceeded. As noted above, this can be determined by tracking the trends in the operational parameter values. If an upward trend is observed over a sufficiently long period, for example, the trend can be extrapolated to determine if the load will exceed the high load threshold within a fixed future period. Alternatively, a high load can sometimes be predicted on the basis of historical trends. Upcoming sports event or music releases may be known to trigger higher demand. If such events are upcoming, then this too can affect the decision at 730. If a high load is expected, then the processing load of the local distribution node can be designated as load (720). Otherwise, the processing load is deemed to be not excessive.

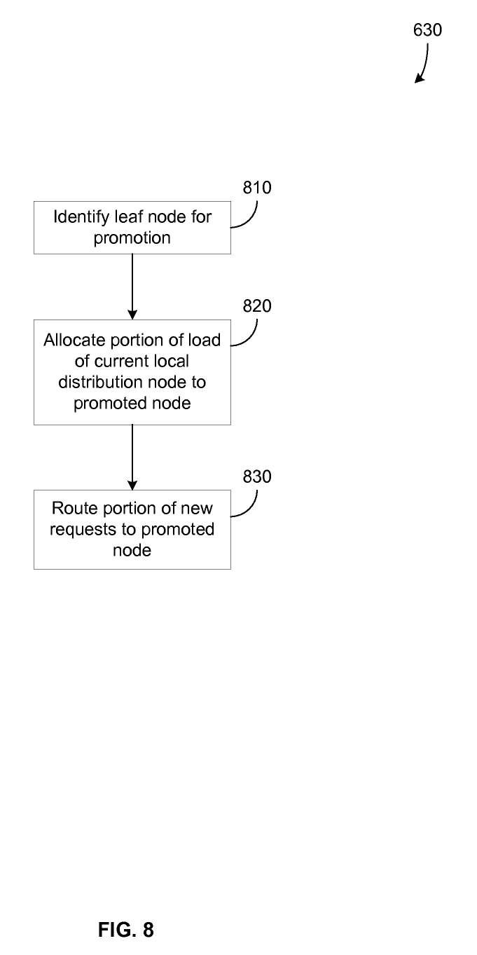

The promotion process 630 is illustrated in greater detail in FIG. 8. At 810, a leaf node is identified for promotion. This selection may be arbitrary and random; alternatively, a particular leaf node may have been pre-designated for promotion. In another embodiment, the selection of a leaf node for promotion may be based on infrastructure advantages of the particular leaf node, e.g., computational capacity, cache capacity, physical location in the network, etc.

At 820, the portion of the current processing load of the local distribution node is allocated to the promoted leaf node. In an embodiment, this allocation includes the mapping of a portion of the existing leaf nodes to the promoted node, such that content requests from this portion of the leaf nodes are directed to the promoted node. In addition, some or all of the content that has been cached at the first local distribution node may be copied into the cache of the promoted node. This will allow the promoted node to service requests for previously cached content. At 830, the promoted node becomes operational, and new requests from the leaf nodes that are now associated with the promoted node are now received at the promoted node. Note that in some embodiments, more than one leaf node may have to be promoted if demand so dictates.

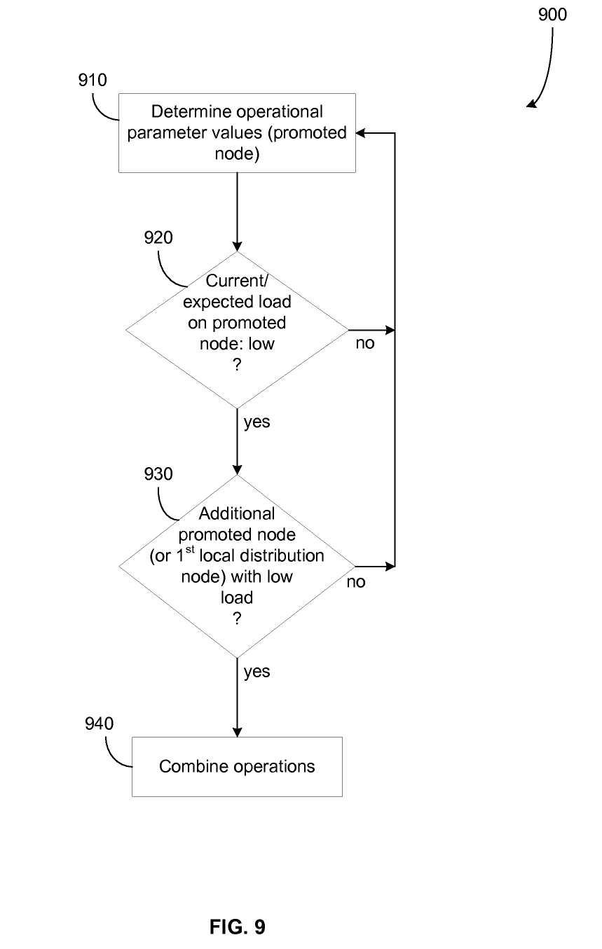

In an embodiment, the promotion of a leaf node is not necessarily permanent. If and when conditions allow, the promoted node can be demoted back to leaf node status. This can take place, for example, when the overall demand for content subsides, such that the system can operate using only the first local distribution node. The demotion process is illustrated in FIG. 9, according to an embodiment. At 910, values for operational parameters at the promoted node are determined. In an embodiment, these parameters may be the same as those considered with respect to the first local distribution node at 610. At 920, a determination is made as to whether the current or expected load on the promoted node is sufficiently low to motivate demotion of the promoted node. If so, then at 930 a determination is made as to whether the processing load at the original local distributional node or at another promoted node is sufficiently low. If such a node also has a sufficiently low processing load, then the loads of the two nodes can be combined; in contrast, if only the first promoted node has a low processing load, its load cannot necessarily be combined with that of another without overwhelming the latter node. If the determination at 930 is affirmative, then at 940 the loads can be combined, such that the load of the promoted node is shifted to the local distribution node. The promoted node is demoted, so that it no longer acts as a local distribution node. The combination of operations at 940 includes the remapping of leaf nodes to the first local distribution node, so that content requests from those leaf nodes are now routed to the first local distribution node. Moreover, the cache contents of the demoted node are copied to the first local distribution node if not already present.

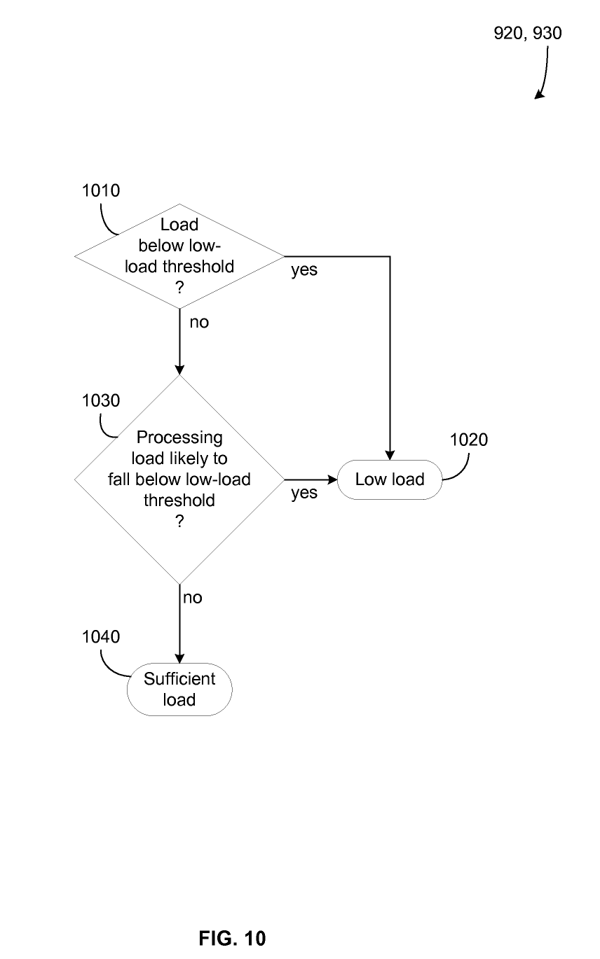

The determination at 920 and 930 as to whether the current or expected processing loads are sufficiently low is illustrated in greater detail in FIG. 10, according to an embodiment. At 1010, a determination is made as to whether the processing load at the promoted node is below a low-load threshold. Such a threshold can be determined empirically or may be a predetermined arbitrary level. If the load is below this threshold, then the load at the promoted node is deemed to be sufficiently low. Otherwise, processing continues at 1030. Here, a determination is made as to whether the processing load at the promoted node is likely to fall below the low-load threshold. This determination can be made on the basis of trends in the values of operating parameters, or can be based on expected lulls in demand for content. To make this determination, values of operational parameters can be monitored to see if they are trending over a predefined period towards a low load condition. If extrapolation of this trend shows that a low load condition will be reached within a defined future period, the processing load will be determined to be likely to fall below the low load threshold. If the outcome of 1030 is affirmative, then the load at the promoted node is deemed to be sufficiently low (1020). Otherwise the new processing load is sufficiently high (1040), so that demotion is not appropriate.

Cooperative Leaf Nodes

In an embodiment, the leaf nodes can have additional functionality that enables them to cooperate in the distribution of requested content. In such an embodiment, the leaf nodes are made aware of the content that has been previously distributed to other leaf nodes. The recipients of a content item save a copy of this content; subsequent requesting leaf nodes can then obtain the content from a node that has previously saved the content. In this manner, the cache functionality of the local distribution is distributed throughout the community of leaf nodes, so that any leaf node that holds a content item can serve as a local source of that content.

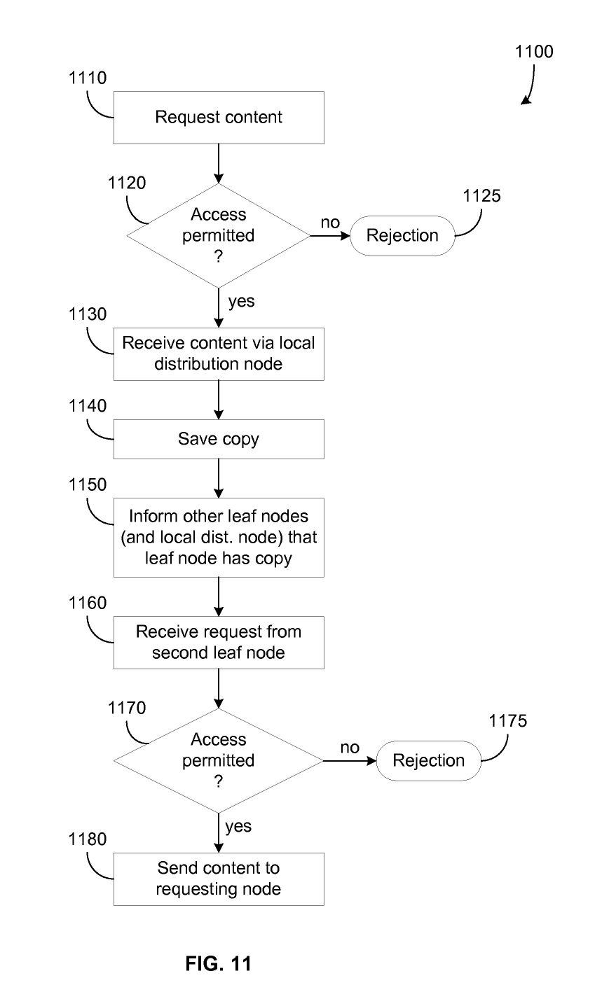

Processing at a leaf node that initially requests a content item is illustrated in FIG. 11, according to an embodiment. At 1110 the leaf node makes a request for the content item. As described above, this request is made through a local distribution node, and includes information about the leaf node and/or the user associated with the leaf node. At 1120, a determination is made as to whether access to the requested content is permitted, per an access policy. If access is not permitted, then the request is rejected (1125).

Otherwise, processing continues at 1130. Here, the requested content is received via the local distribution node. At 1140 the leaf node saves a copy of the requested content. At 1150, the leaf node informs the other nodes (i.e., the other leaf nodes and the local distribution node) that this leaf node has a copy of the content item. This communication can take place using any protocol known to persons of ordinary skill in the art, such as a peer-to-peer or other protocol. In the illustrated embodiment, the leaf node actively informs the other leaf nodes that the content has been obtained. Alternatively, the local distribution node may so inform the other leaf nodes. In another embodiment, the presence of the content at the leaf node is only discovered by another leaf node when the latter makes a request to the local distribution node; the local distribution node may then inform this latter requesting node that another leaf node has a copy of the content. Alternatively, this latter requesting node may broadcast its request to the other leaf nodes, and can then learn that the content is available through a response from any leaf node that is holding the content.

At 1160, the leaf node that initially received the content receives a request from another leaf node seeking the content item. At 1170, a determination is made as to whether this latter leaf node may access this content. In an embodiment, the access policy may have been sent to the first leaf node, enabling the first leaf node to make the access decision 1170. Alternatively, the user information of the second leaf node may be relayed to the local distribution node, where the access decision 1170 may then be made; this decision would then be sent to the first leaf node. In either case, if the second leaf node is not permitted access to the content item, then this request is rejected (1175). Otherwise, the content is sent from the first leaf node to the second leaf node. Again, this transmission may take place using any protocol known to persons of ordinary skill in the art, such as a peer-to-peer or other protocol.

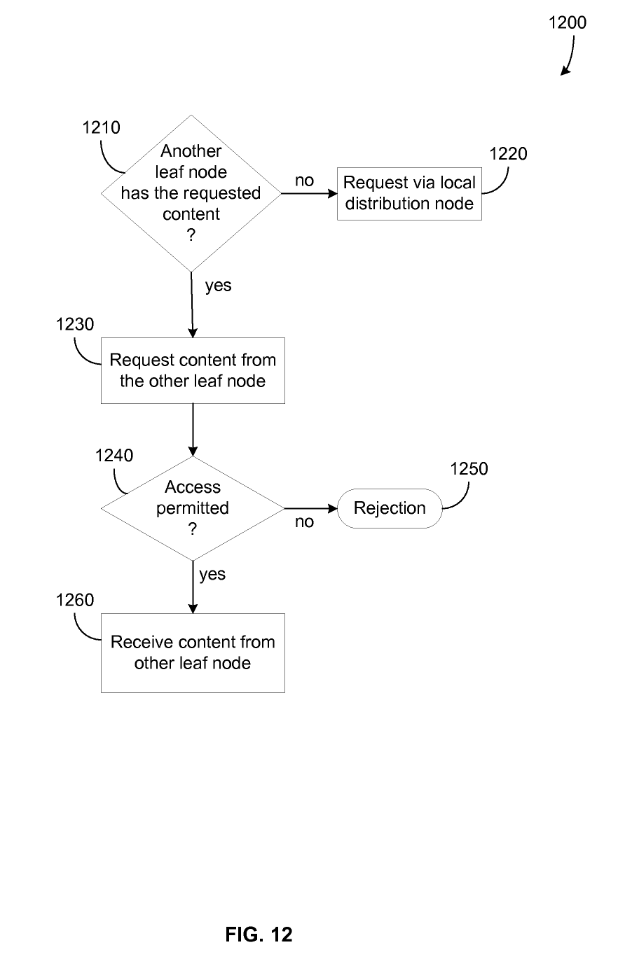

Processing at the second leaf node is illustrated in FIG. 12, according to an embodiment. At 1210, this leaf node determines whether another leaf node has the desired content. Recall that when any leaf node obtains content through the content distribution system, it retains a copy and the other leaf nodes are informed of this (1140, 1150 above). If, at 1210, the second leaf node determines that the desired content is not available from another leaf node, then the request can be made via the local distribution node at 1220. Otherwise, another leaf node is found to have the desired content and the content is requested from that leaf node at 1230. In the illustrated embodiment, the request of 1230 is directed to a specific leaf node; alternatively, the requesting leaf node may broadcast a query and request to all the other leaf nodes to determine which leaf node, has a copy of the desired content.

At 1240, a determination is made as to whether the requesting leaf node has permission to access the content, as described above. If not, the request is rejected at 1250. Otherwise, the content is received at the requesting leaf node.

Bandwidth Allocation

In an embodiment, the local distribution node may include network management functionality. The local distribution node can adaptively allocate and reallocate bandwidth to particular leaf nodes as demands require, for example.

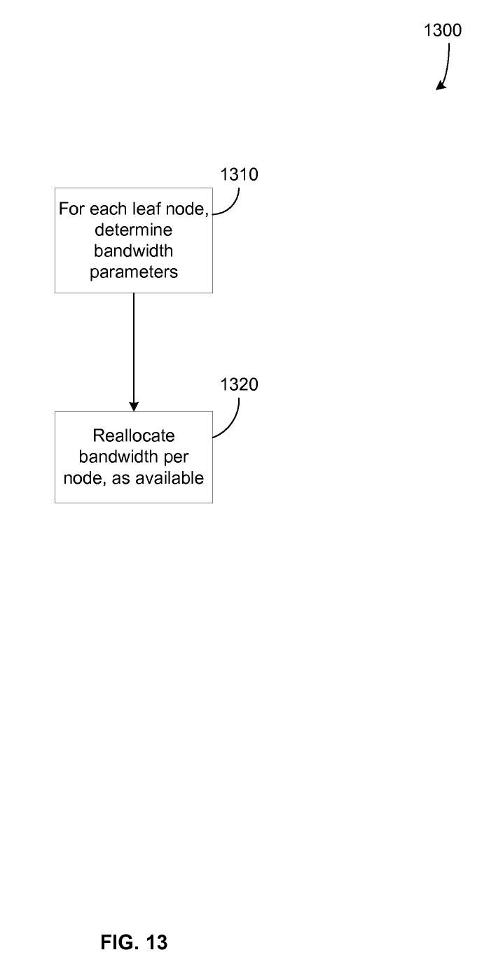

This is illustrated at FIG. 13, according to an embodiment. At 1310, bandwidth parameters are determined at the local distribution node for each leaf node. As will be discussed below, these parameters include properties of the leaf node and of the system as a whole, where these properties impact the bandwidth needs and bandwidth availability for the leaf node. At 1320, reallocation may be performed, as feasible.

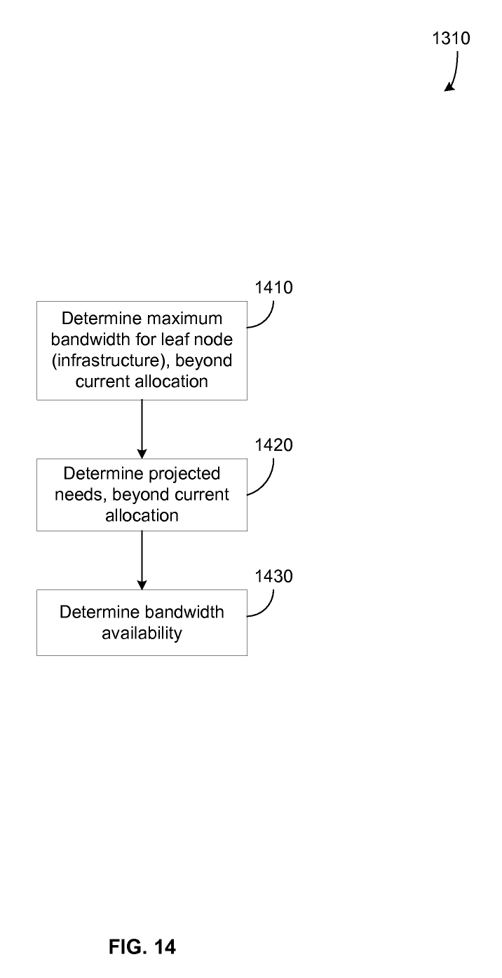

The determination of bandwidth parameters for each leaf node is illustrated in FIG. 14 according to an embodiment. At 1410, the maximum bandwidth capacity for a leaf node is determined, beyond the current bandwidth allocation for the leaf node. This maximum bandwidth capacity is based on the infrastructure of the leaf node, to include, for example, the physical layer capacity for the node, the processing capacity of the node, etc. At 1420, the projected bandwidth needs of the leaf node are determined, beyond the current bandwidth allocation, for a predefined future period. This projection process is discussed in greater detail below. At 1430, the bandwidth available for allocation to the leaf node is determined, based on systemic availability.

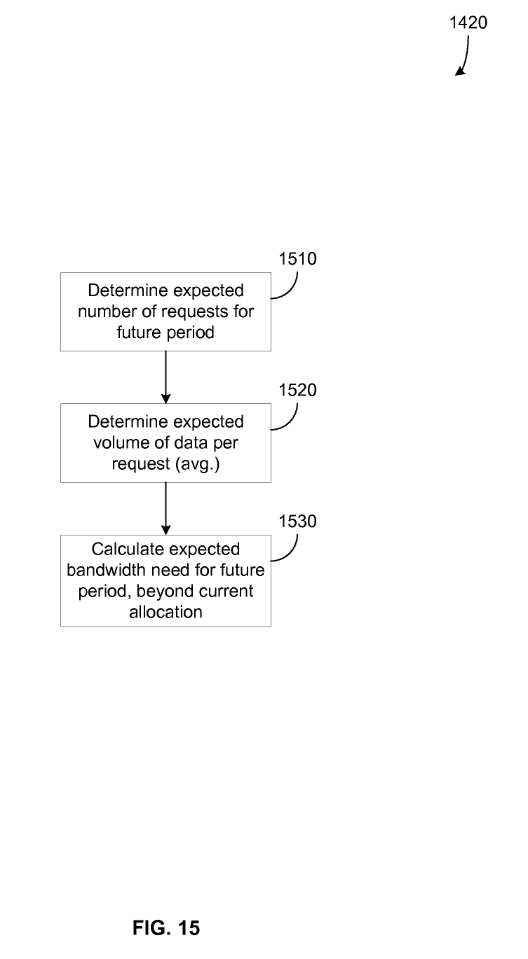

The determination of projected bandwidth needs for the leaf node (1420) is illustrated in FIG. 15, according to an embodiment. At 1510, the expected number of content requests for the future period is determined. At 1520, the average expected volume of data per request is determined. These values (1510 and 1520) can be determined on the basis of historical records and/or apparent trends, in an embodiment. At 1530, the expected bandwidth needs of the leaf node for the future period beyond the current allocation are calculated based on the determinations 1510 and 1520.

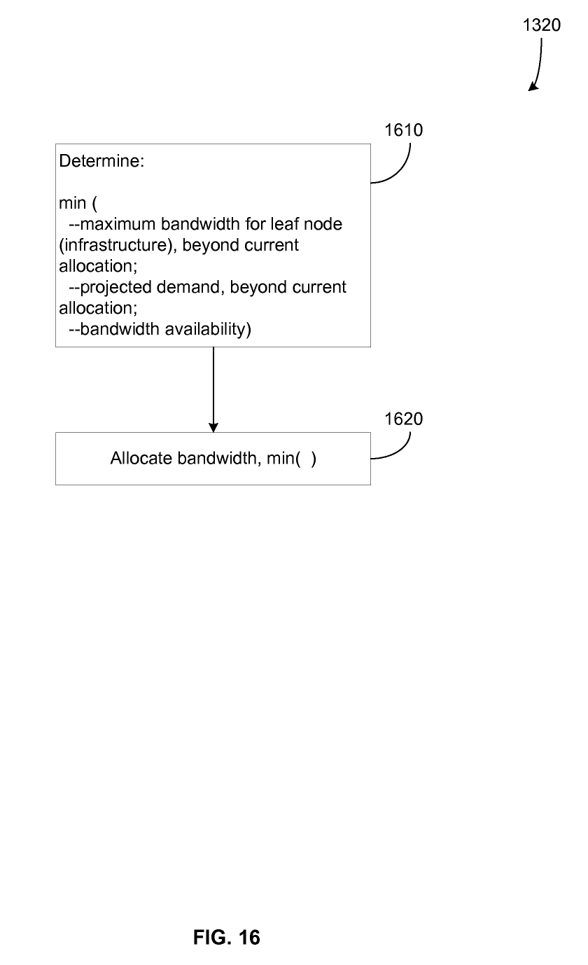

Bandwidth reallocation (1320) is illustrated in FIG. 16, according to an embodiment. At 1610, the minimum of three values is determined, (1) the maximum bandwidth for the leaf node based on its infrastructure, beyond its current bandwidth allocation, (2) the projected bandwidth needs of the leaf node, beyond its current bandwidth allocation, and (3) the amount of bandwidth available for reallocation to the leaf node. At 1620, this minimum amount of bandwidth is allocated to the leaf node.

Note that in some embodiments, the amount of bandwidth available for reallocation to the leaf node will depend on a prioritization of leaf nodes. Some leaf nodes may be given priority over other nodes based on, for example, business considerations. Some users may be subscribers to particular content packages, some of which may be treated as premium packages that entitle the user to better service, i.e., greater bandwidth than other users, and will have paid a higher subscription fee than other users. Such considerations may be taken into account at 1420, the determination of the amount of bandwidth available for reallocation.

Channel Surfing

The ability of a local distribution node to cache content can be used to improve the channel surfing process for a user. When a user normally channel surfs, each selection of another channel represents another request for content. Accessing that content includes some latency when the content is accessed from the content provider. This becomes problematic if the user is repeatedly selecting the next channel during the surfing process. Moreover, once the user settles on a channel, there may be a gap between what he may have seen briefly while channel surfing and the content as presented to him once he commits to that channel. The intervening content may be lost.

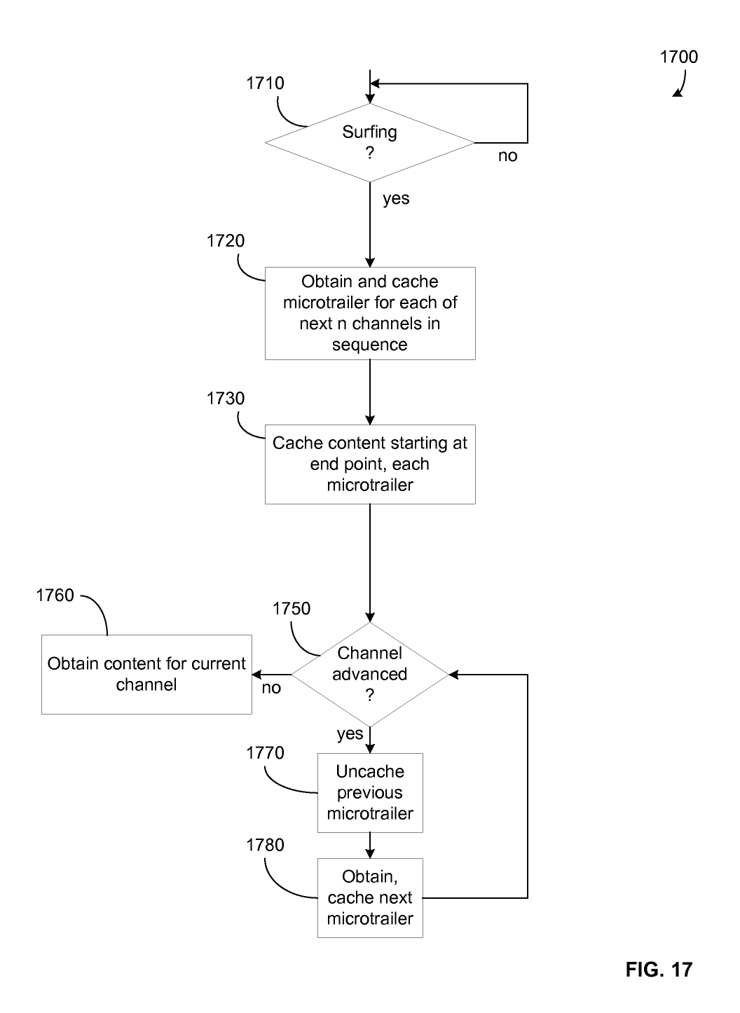

The cache of the local distribution node can be used to address these problems. The processing at the local distribution node is illustrated in FIG. 17, according to an embodiment. At 1710, a determination is made as to whether a user at a leaf node is channel surfing. This determination will be described in greater detail below. At 1720, the local distribution node obtains and caches a “microtrailer” for each of the next n channels beyond the channel currently being viewed by the user while surfing. The microtrailer would be obtained from the content provider. A microtrailer represents a brief interval of content that the user may glimpse on a channel while surfing. In an embodiment, the microtrailer may be a low bandwidth version of this interval.

At 1730, additional content is obtained from the content provider for each of the n channels and cached, starting from the endpoint of each microtrailer. At 1750, a determination is made as to whether the user has advanced to the next channel. If not, then it is assumed that the user has stopped channel surfing, and at 1760 content is distributed to the leaf node of the user. If a microtrailer for this channel had already been distributed to this leaf node, the content obtained at 1760 starts at the endpoint of the microtrailer. If a microchannel for this channel was not previously sent to the leaf node, then the content for the channel is obtained via the local distribution node in the normal manner (if it has not been otherwise cached).

If, at 1750, the channel has advanced (i.e., if the user continues to channel surf), then at 1770 the microtrailer from the previously surfed channel is removed from the cache. At 1780, a next microtrailer (beyond the previously obtained n micro trailers) is obtained from the content provider and cached. Processing would then continue at 1750. The processing illustrated by 1750, 1770, and 1780 will continue as long as the user continues to channel surf.

The processing of FIG. 7 is described above in terms of channel surfing in an upward direction (i.e., channel n, then channel n+1, n+2, etc.). Processing would proceed in an analogous manner if the user is instead proceeding through a decrementing sequence of channels.

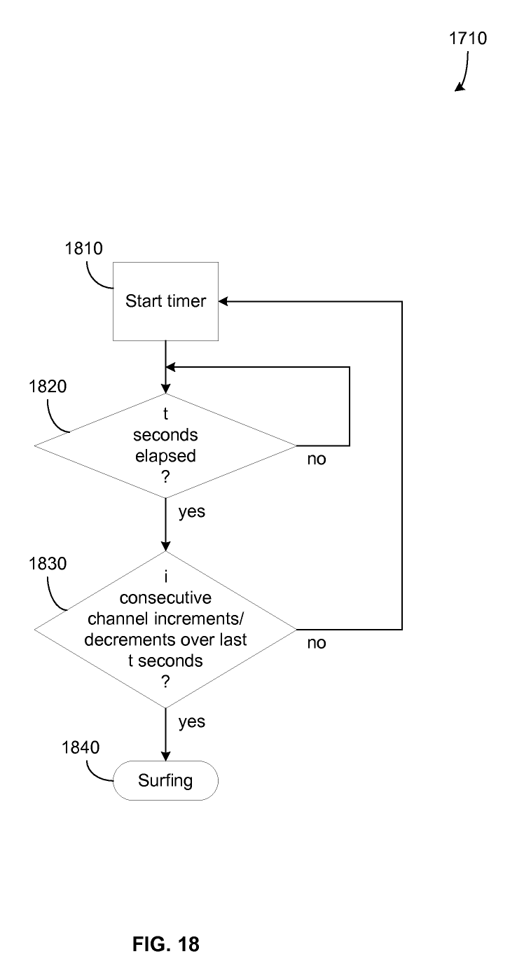

The determination of whether a leaf node is channel surfing (1710) is illustrated in greater detail in FIG. 18, according to an embodiment. Here, a timer starts at 1810. At 1820, a determination is made as to whether a predefined time period (shown as t seconds) has elapsed as measured by the timer. If not, then 1820 repeats. If so, then at 1830 a determination is made as to whether there have been i consecutive channel increments (or decrements) since the timer started, i.e., over the past t seconds. If so, then it is determined that channel surfing is taking place (1840). The values of i and t may be determined empirically in an embodiment. In the illustrated embodiment, the detection of channel surfing is performed at the local distribution node.

Note that the process as illustrated in FIG. 18 looks for surfing behavior in consecutive non-overlapping windows of t seconds each. In an alternative embodiment, channel surfing could be detected using a moving window oft seconds instead.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including at least one computer readable medium having computer program logic stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a compact disk, a flash memory, or other data storage device.

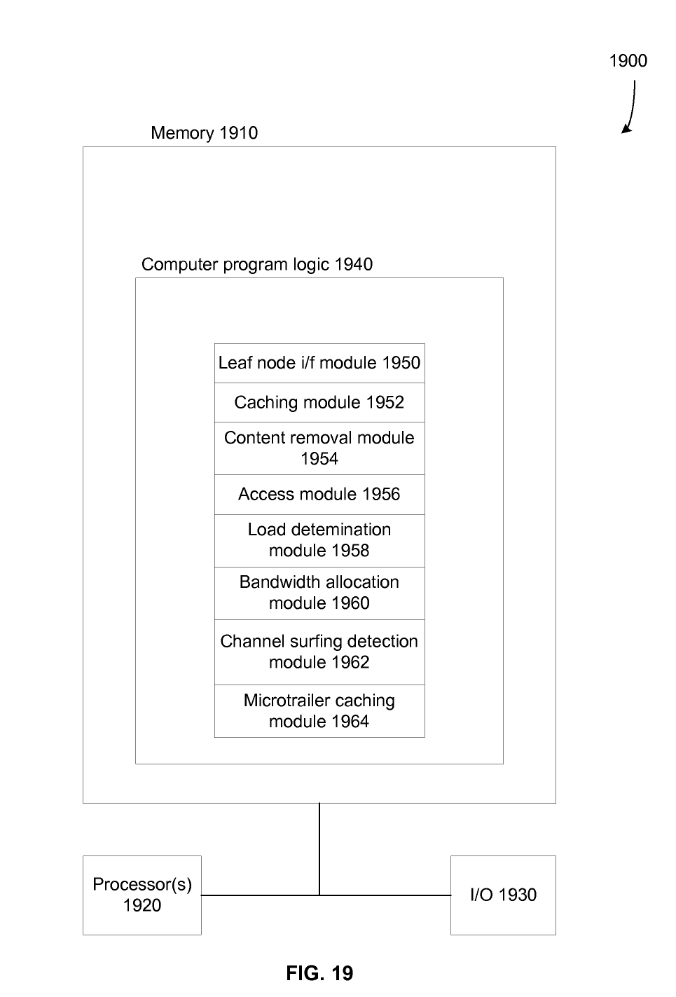

In an embodiment, some or all of the processing described herein may be implemented as software or firmware. Such a software or firmware embodiment at a server is illustrated in the context of a computing system 1900 in FIG. 19. System 1900 can represent a local distribution node, and includes one or more central processing unit(s) (CPU), shown as processor(s) 1920 acting as the event processor. System 1900 includes a body of memory 1910 that includes one or more non-transitory computer readable media that store computer program logic 1940. Memory 1910 may be implemented as a read-only memory (ROM) or random access memory (RAM) device, for example. Processor(s) 1920 and memory 1910 may be in communication using any of several technologies known to one of ordinary skill in the art, such as a bus or a point-to-point interconnect. Computer program logic 1940 contained in memory 1910 may be read and executed by processor(s) 1920. In an embodiment, one or more I/O ports and/or I/O devices, shown collectively as I/O 1930, may also be connected to processor(s) 1920 and memory 1910. In an embodiment, I/O 1930 may include the communications interface(s) to the content provider and to the leaf nodes.

In the embodiment of FIG. 19, computer program logic 1940 includes a module 1950 responsible for interfacing (i/f) with leaf nodes, to include receipt of content requests and user information, distribution of content, and encryption and/or authentication processes. Computer program logic 1940 also includes a module 1952 responsible for determining whether to cache content and for caching the content. Computer program logic 1940 includes a module 1954 responsible for determining whether to remove content from the cache, and for removing the content. Computer program logic 1940 also includes a module 1956 responsible for application of an access policy.

Computer program logic 1940 also includes a module 1958 for determination of the current and expected processing load at the local distribution node. Computer program logic 1940 also includes a module 1960 for allocation of the processing load of the local distribution node to a promoted leaf node. Logic 1940 can also include a module 1960 for performing bandwidth allocation for leaf nodes.

Computer program logic 1940 also includes a module 1962 for the detection of channel surfing. Logic 1940 also includes a microtrailer caching module 1964 to effect the caching of microtrailers and the removal of microtrailers when necessary.

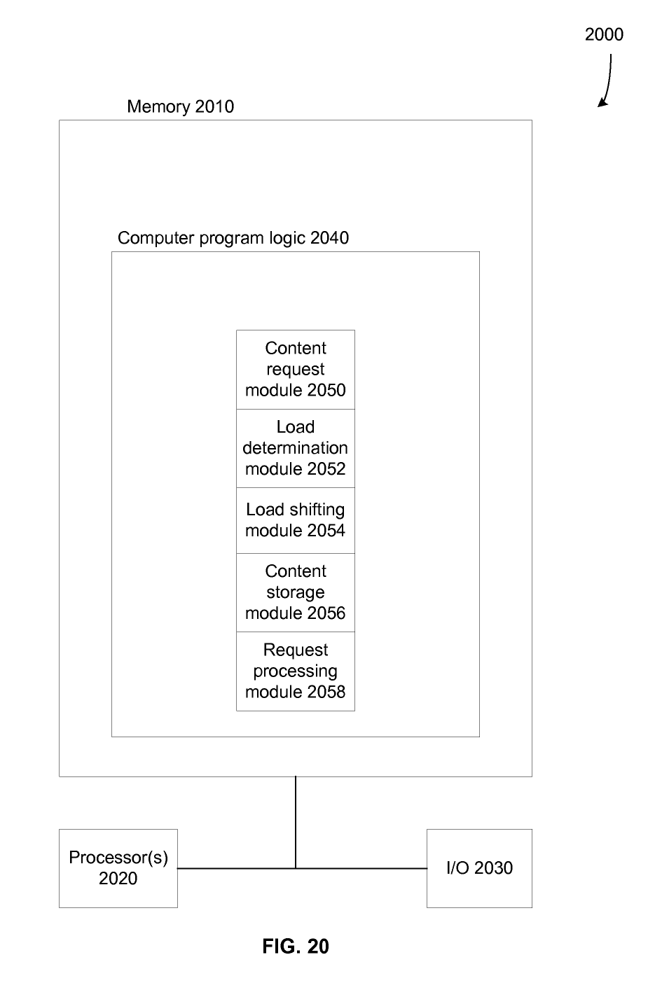

A software or firmware embodiment of the processing described above at a leaf node is illustrated in the context of a computing system 2000 in FIG. 20. System 2000 can represent a local distribution node, and includes one or more central processing unit(s) (CPU), shown as processor(s) 2020 acting as the event processor. System 2000 includes a body of memory 2010 that includes one or more non-transitory computer readable media that store computer program logic 2040. Memory 2010 may be implemented as a read-only memory (ROM) or random access memory (RAM) device, for example. Processor(s) 2020 and memory 2010 may be in communication using any of several technologies known to one of ordinary skill in the art, such as a bus or a point-to-point interconnect. Computer program logic 2040 contained in memory 2010 may be read and executed by processor(s) 2020. In an embodiment, one or more I/O ports and/or I/O devices, shown collectively as I/O 2030, may also be connected to processor(s) 2020 and memory 2010. In an embodiment, I/O 2030 may include the communications interface(s) to the local distribution node and to one or more other leaf nodes.

In the embodiment of FIG. 20, computer program logic 2040 includes a content request module for constructing and sending a content request to the local distribution node and/or to one or more other leaf nodes. Computer program logic 2040 also includes a module 2052 for determining a current and expected processing load at the leaf node, for purposes of deciding on whether demotion is appropriate. Computer program logic 2040 also includes a module 2054 for shifting its processing load to the local distribution node in the event of demotion. A content storage module 2056 is also present, to enable saving of content locally at the leaf node for possible distribution to another leaf node. Computer program logic 2040 also includes a module 2058 for processing of content requests from other leaf nodes, where such request processing includes the determination of access permission in an embodiment.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method of content distribution, comprising:
at a first leaf node of a content distribution network, requesting content from a local distribution node;
if access is permitted, receiving the content from the local distribution node;
recording the content; and
sending the content to a second leaf node.

2. The method of claim 1, wherein the content is sent to the second leaf node in response to a request from the second leaf node.

3. The method of claim 2, wherein access permission is verified by the first leaf node before the content is sent to the second leaf node.

4. The method of claim 3, wherein the verification comprises one or more of:
authenticating the request; and
determining the access rights of the second leaf node with respect to the content.

5. The method of claim 2, wherein one or more of
the request, and
the content sent to the second leaf node are encrypted.

6. The method of claim 1, further comprising:
informing other nodes of the content distribution network that the first leaf node is in possession of the content,
performed after said recording of the content.

7. A computer program product for content distribution, including a non-transitory computer readable medium having computer program logic stored therein, the computer program logic comprising:
at a first leaf node of a content distribution network, logic for requesting content from a local distribution node;
logic for receiving the content from the local distribution node, if access is permitted;
logic for recording the content; and
logic for sending the content to a second leaf node.

8. The computer program product of claim 7, wherein the content is sent to the second leaf node in response to a request from the second leaf node.

9. The computer program product of claim 8, wherein access permission is verified by the first leaf node before the content is sent to the second leaf node.

10. The computer program product of claim 9, wherein the verification comprises one or more of:
authenticating the request; and
determining the access rights of the second leaf node with respect to the content.

11. The computer program product of claim 8, the computer program logic further comprising:
logic for encrypting one or more of
the request, and
the content sent to the second leaf node.

12. The computer program product of claim 7, the computer program logic further comprising:
logic for informing other nodes of the content distribution network that the first leaf node is in possession of the content, performed after the recording of the content.

13. A system for content distribution, comprising:
a processor; and
memory in communication with said processor, said memory for storing a plurality of processing instructions for directing said processor to:
at a first leaf node of a content distribution network, request content from a local distribution node;
if access is permitted, receive the content from the local distribution node;
recording the content; and
sending the content to a second leaf node.

14. The system of claim 13, wherein the content is sent to the second leaf node in response to a request from the second leaf node.

15. The system of claim 14, wherein access permission is verified by the first leaf node before the content is sent to the second leaf node.

16. The system of claim 15, wherein the verification comprises one or more of:
authenticating the request; and
determining the access rights of the second leaf node with respect to the content.

17. The system of claim 14, wherein the processing instructions further direct said processor to encrypt one or more of
the request, and
the content sent to the second leaf node.

18. The system of claim 13, wherein the processing instructions further direct said processor to:
inform other nodes of the content distribution network that the first leaf node is in possession of the content,
performed after said recording of the content.
